(19) United States
(12) Patent Application Publication
(10) Pub. No.: US 2005/0104980 A1
(43) Pub. Date: May 19, 2005

(54) Photographing system for controlling a photographing device according to a control command made by combining plural remote control signals and control method thereof

(76) Inventors: Hak-je Kim, Suwon-si (KR); Hye-young Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/951,720

(22) Filed: Sep. 29, 2004

(30) Foreign Application Priority Data
Nov. 18, 2003 (KR) 2003-81547

(51) Int. Cl. H04N 5/262

(52) U.S. Cl. 348/240.99

(57) ABSTRACT

A photographing system capable of controlling a photographing device by combining a plurality of remote control signals output from a remote controller and a control method thereof. The photographing system includes a photographing part for outputting an image signal, an input part provided with first and second manipulation buttons for inputting first and second control commands, respectively, by selecting at least one of the first and second manipulation buttons, and a control part for controlling the photographing part in accordance with any one of the first and second control commands if the corresponding one of the first and second manipulation buttons is selected, and controlling the photographing part in accordance with a third control command if both the first and second manipulation buttons are selected.

### CROSS-REFERENCE TO RELATED APPLICATIONS

This application claims the benefit under 35 U.S.C. § 119(a) of Korean Patent Application No. 2003-81547, filed in the Korean Intellectual Property Office on Nov. 18, 2003, the entire contents of which are incorporated herein by reference.

### BACKGROUND OF THE INVENTION

1. Field of the Invention

The present invention relates to a photographing system and a control method thereof. More particularly, the present invention relates to a photographing system which can input control commands to a photographing device using a remote controller provided with a plurality of manipulation buttons, and a control method thereof.

2. Description of the Related Art

With the development of data transmission technology, an image photographed by and transmitted from a photographing device installed in a place, can be viewed in another place that is far removed from the place where the photographing device is installed. For example, a CCTV camera may be installed in an area where security is required or in a crime-prone area, and a superintendent in his/her office may monitor the area. Also, a camera may be installed in a high traffic area, and a supervisor in a central control office may check the road capacity of the area by monitoring the traffic of the area.

FIG. 1 is a block diagram of a conventional photographing system. As shown in FIG. 1, the conventional photographing system includes a photographing device 10, a recording/reproducing device 20, and a remote controller 30.

The photographing device 10 provides an image signal, created by capturing an image of an object, to the recording/reproducing device 20, and controls respective modules in accordance with user's control commands input through a key input part 15 or the remote controller 30. The photographing device 10 includes a photographing part 11, a main control part 13, the key input part 15, and a remote control signal transferring part 17.

The photographing part 11 captures the image of the object, and provides the image signal to the recording/reproducing device 20 under the control of the main control part 13.

The main control part 13 receives the user's control commands through the key input part 15 or the remote controller 30, and controls the operation of the photographing part 11 accordingly.

The remote control signal transferring part 17 provides remote control signals output from the remote controller 30 to the main control part 13.

The recording/reproducing device 20 receives the image signal output from the photographing device 10, and displays the image signal on a display device or records the image signal in a recording medium.

The remote controller 30 is provided to allow the user to remotely input the control commands to the photographing device 10, and is provided with a plurality of manipulation buttons. The respective buttons are configured for inputting the different control commands.

Hereinafter, the process of transferring control commands input by the user through the remote controller 30 to the main control part 13, and the process of controlling the photographing part 11, which is performed by the main control part 13 having received the control commands, will be described in greater detail referring to FIGS. 2 and 3.

FIG. 2 is a schematic illustrating the process of applying remote control signals output from a remote controller 30 of FIG. 1 to a main control part 13 through a remote control signal transferring part 17. In FIG. 2, the remote controller 30 is provided with a “WIDE” button 31 for reducing a zoom magnification, a “TELE” button 33 for enlarging a zoom magnification, a “FAR” button 35 for adjusting a focus to a long distance, and a “NEAR” button 37 for adjusting a focus to a short distance.

The remote control signal transferring part 17 is provided with three terminals, i.e., “Zoom”, “Com.” and “Focus” terminals, for receiving the remote control signals output from the remote controller 30. The main control part 13 is provided with four ports “ZW (Zoom_Wide)”, “ZT (Zoom_Tele)”, “FF (Focus_Far)” and “FN (Focus_Near)” for receiving logic-level signals output from the remote control signal transferring part 17.

If the user selects the “WIDE” button 31, a voltage of +5V is applied between the “Zoom” and “Com.” terminals of the remote control signal transferring part 17. Accordingly, only the first light emitting diode (LED) D₁ and the first phototransistor Tr₁ are turned on, and this causes a low-level signal to be input to the “ZW” port of the main control part 13. In this case, the second to fourth light emitting diodes LEDS D₂ to D₄, and the second to fourth phototransistors Tr₂ to Tr₄ are turned off, and this causes a high-level signal to be input to the “ZT”, “FF” and “FN” ports of the main control part 13.

If the user selects the “TELE” button 33, a voltage of −5V is applied between the “Zoom” and “Com.” terminals of the remote control signal transferring part 17. Accordingly, only the second LED D₂ and the second phototransistor Tr₂ are turned on, and this causes a low-level signal to be input to the “ZT” port of the main control part 13. In this case, the first, third and fourth LEDS D₁, D₃ and D₄, and the first, third and fourth phototransistors Tr₁, Tr₃ and Tr₄ are turned off, and thus a high-level signal is input to the “ZW”, “FF” and “FN” ports of the main control part 13.

If the user selects the “FAR” button 35, a voltage of +5V is applied between the “Focus” and “Com.” terminals of the remote control signal transferring part 17. Accordingly, only the third LED D₃ and the third phototransistor Tr₃ are turned on, and this causes a low-level signal to be input to the “FF” port of the main control part 13. In this case, the first, second and fourth LEDS D₁, D₂ and D₄, and the first, second and fourth phototransistors Tr₁, Tr₂ and Tr₄ are turned off, and this causes a high-level signal to be input to the “ZW”, “ZT” and “FN” ports of the main control part 13.

If the user selects the “NEAR” button 37, a voltage of −5V is applied between the “Focus” and “Com.” terminals of the remote control signal transferring part 17. Accordingly, only the fourth LED D₄ and the fourth phototransistor Tr₄ are turned on, and this causes a low-level signal to be input to the “FN” port of the main control part 13. In this case, the first to third LEDS D₁ to D₃, and the first to third phototransistors Tr₁ to Tr₃ are turned off, and this causes a high-level signal to be input to the “ZW”, “ZT” and “FF” ports of the main control part 13.

As described above, in accordance with the voltages applied between the “Zoom” and “Com.” terminals, or between the “Focus” and “Com.” terminals, the logic levels input to the four ports “ZW”, “ZT”, “FF” and “FN” of the main control part 13 can be controlled, examples of which are shown in Table 1 below.

TABLE 1

| | | Logic Levels Input | | | |
|---|---|---|---|---|---|
| Input Terminals of Remote | Input Voltage | to Main Control | | | |
| Control Signal | (V) between | Part 13 | | | |
| Transferring Part 17 | terminals | ZW | ZT | FF | FN |
| Zoom | +5 | L | H | — | — |
| Com. | −5 | H | L | — | — |
| | 0 | H | H | — | — |
| Focus | +5 | — | — | L | H |
| Com. | −5 | — | — | H | L |
| | 0 | — | — | H | H |

FIG. 3 is a flowchart provided for explaining the process of controlling a photographing part 11 by selecting manipulation buttons 31 to 37 provided in a remote controller 30. Referring to FIG. 3, if the user selects any one of the manipulation buttons 31 to 37 provided in the remote controller 30 to input a control command to the photographing device 10, a low-level signal is input to the corresponding one of the four ports “ZW”, “ZT”, “FF” and “FN” of the main control part 13 as shown in FIG. 2 at step S41. At this time, if the photographing part 11 is performing a focusing operation or a zooming operation, the control command input by the user is disregarded in order to continuously maintain the focusing operation or the zooming operation being performed at steps S51 and S53.

If the photographing part 11 is not performing the focusing operation or the zooming operation, the main control part 13 performs the control command corresponding to the manipulation button selected at step S41 at steps S61 to S93.

If the user selects the “WIDE” button 31 at step S41 and a low-level signal is input to the “ZW” port of the main control part 13 at step S61, the main control part 13 reduces the zoom magnification by driving a zooming motor provided in the photographing part 11 in a “Wide” direction at step S63.

If the user selects the “TELE” button 33 at step S41 and a low-level signal is input to the “ZT” port of the main control part 13 at step S71, the main control part 13 enlarges the zoom magnification by driving the zooming motor provided in the photographing part 11 in a “Tele” direction at step S73.

If the user selects the “FAR” button 35 at step S41 and the low-level signal is input to the “FF” port of the main control part 13 at step S81, the main control part 13 moves the focus to a long distance by driving a focusing motor provided in the photographing part 11 in a “Far” direction at step S83.

If the user selects the “NEAR” button 37 at step S41 and the low-level signal is input to the “FN” port of the main control part 13 at step S91, the main control part 13 moves the focus to a short distance by driving the focusing motor provided in the photographing part 11 in a “Near” direction at step S93.

As described above, according to the conventional photographing system, the user can input control commands for a zooming function and a focusing function of a photographing device 10 using a remote controller 30. However, the control commands, which can be input by the user through the remote controller 30, are limited to the zooming function and the focusing function, and the user must use a key input part 15 provided in the photographing device 10 in order to input other control commands. Accordingly, in the event that the photographing device 10 is located in a remote location, such as on a ceiling of a building, it is difficult for the user to directly manipulate the key input part 15.

To overcome this problem, separate equipment may be installed so that the control commands are input using a serial communication between a user's PC and the photographing device 10. However, this causes the photographing system to become complicated and have an increased cost.

The number of manipulation buttons provided in the remote controller 30 may be increased in order to accommodate more control commands, however, in the event that the main control part 13 is limited in number of ports allocated to receive the remote control signals, it becomes difficult to increase the number of manipulation buttons.

Accordingly, a need exists for a photographing system and method capable of receiving an increased number of control commands, both locally and remotely, without requiring an increase in the number of ports allocated to receive the remote control signals.

### SUMMARY OF THE INVENTION

The present invention has been developed in order to solve the above drawbacks and other problems associated with the conventional arrangement. An object of the present invention is to provide a photographing system capable of inputting control commands to a photographing device using a remote controller provided with a plurality of manipulation buttons and a control method thereof, which enables the photographing device to perform a control operation in accordance with a new control command. The control command can be provided by combining a plurality of remote control signals input to the photographing device by simultaneously selecting the plurality of manipulation buttons.

The foregoing and other objects and advantages are substantially realized by providing a photographing system according to the present invention, which comprises a photographing part for converting an optical signal incident through a lens part into an electric signal, and for outputting an image signal created through a specified signal process of the converted electric signal. The system further comprises an input part, provided with first and second manipulation buttons for inputting first and second control commands, respectively, by selecting at least one of the first and second manipulation buttons, and a control part for controlling the photographing part in accordance with any one of the first and second control commands if the corresponding one of the first and second manipulation buttons is selected, and for controlling the photographing part in accordance with a third control command if both the first and second manipulation buttons are selected.

It is preferable that the control part controls the photographing part in accordance with a fourth control command if both the first and second manipulation buttons are continuously selected for more than a predetermined time.

Preferably, the input part further includes a third manipulation button for inputting any one of the third and fourth control commands, and the control part controls the photographing part in accordance with the third control command if the third manipulation button in the input part is selected for less than a predetermined time, while the control part controls the photographing part in accordance with the fourth control command if the third manipulation button is continuously selected for more than the predetermined time.

Preferably, the control part controls the photographing part in accordance with the third control command if the first manipulation button is continuously selected for more than a predetermined time, while the control part controls the photographing part in accordance with the fourth control command if the second manipulation button is continuously selected for more than the predetermined time.

Preferably, the third control command can comprise one of a menu display command, a restoration command for restoring an environment setting value of the photographing part to a basic value, an auto-focusing setting command and an auto-exposure setting command. Also, the fourth control command can comprise one of a menu display command, a restoration command for restoring an environment setting value of the photographing part to a basic value, an auto-focusing setting command and an auto-exposure setting command.

Another object of the present invention is to provide a method for controlling a photographing system including a photographing part for converting an optical signal incident through a lens part into an electric signal and outputting an image signal created through a specified signal process of the converted electric signal, and an input part having first and second manipulation buttons. The method comprises the steps of: a) selecting at least one of the first and second manipulation buttons; b) controlling the photographing part in accordance with any one of first and second control commands if the corresponding one of the first and second manipulation buttons is selected at step a); and c) controlling the photographing part in accordance with a third control command if both the first and second manipulation buttons are selected at step a).

It is preferable that the method further comprises the step of d) controlling the photographing part in accordance with a fourth control command if both the first and second manipulation buttons are continuously selected for more than a predetermined time at step a).

As the input part can further include a third manipulation button for inputting any one of the third and fourth control commands, the method can further comprise the steps of e) controlling the photographing part in accordance with the third control command if the third manipulation button in the input part is selected for less than a predetermined time at step a), and f) controlling the photographing part in accordance with the fourth control command if the third manipulation button is continuously selected for more than the predetermined time at step a).

The method can further comprise the steps of g) controlling the photographing part in accordance with the third control command if the first manipulation button is continuously selected for more than a predetermined time, and h) controlling the photographing part in accordance with the fourth control command if the second manipulation button is continuously selected for more than the predetermined time.

Preferably, the third control command can comprise one of a menu display command, a restoration command for restoring an environment setting value of the photographing part to a basic value, an auto-focusing setting command and an auto-exposure setting command. Also, the fourth control command can comprise one of a menu display command, a restoration command for restoring an environment setting value of the photographing part to a basic value, an auto-focusing setting command and an auto-exposure setting command.

### BRIEF DESCRIPTION OF THE DRAWINGS

The above aspects and features of the present invention will become more apparent by describing certain embodiments of the present invention with reference to the accompanying drawings, in which:

FIG. 1 is a block diagram of a conventional photographing system;

FIG. 2 is a schematic illustrating a process of applying remote control signals output from a remote controller of FIG. 1 to a main control part through a remote control signal transferring part;

FIG. 3 is a flowchart illustrating a process of controlling a photographing part by selecting manipulation buttons provided in a remote controller;

FIG. 4 is a block diagram illustrating a photographing system according to an embodiment of the present invention;

FIG. 5 is a block diagram illustrating a photographing system which controls a photographing device in accordance with control commands made by combining a plurality of remote control signals output from a remote controller according to an embodiment of the present invention;

FIG. 6 is a schematic illustrating a remote controller of FIG. 5;

FIGS. 7 and 8 are flowcharts illustrating a method for controlling a photographing device in accordance with control commands made by combining a plurality of remote control signals output from a remote controller according to an embodiment of the present invention;

FIG. 9 is a block diagram illustrating a method for controlling a photographing device in accordance with control commands made by combining a plurality of remote control signals output from a remote controller according to another embodiment of the present invention; and

FIG. 10 is a schematic illustrating a remote controller of FIG. 9.

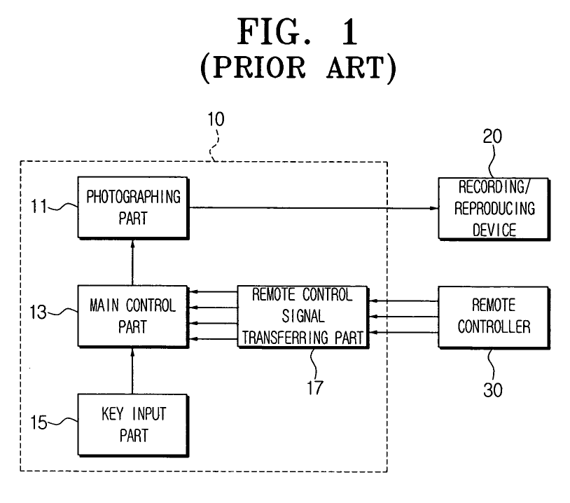

Throughout the drawings, like reference numerals will be understood to refer to like parts, components and structures.

### DETAILED DESCRIPTION OF THE EXEMPLARY EMBODIMENTS

Certain embodiments of the present invention will now be described in greater detail with reference to the accompanying drawings.

In the following description, same drawing reference numerals are used for the same elements, even where found in different drawings. The matters defined in the description, such as detailed construction and element descriptions, are provided as examples to assist in a comprehensive understanding of the invention. Also, functions or constructions well known to those skilled in the art are not described since they would obscure the invention in unnecessary detail.

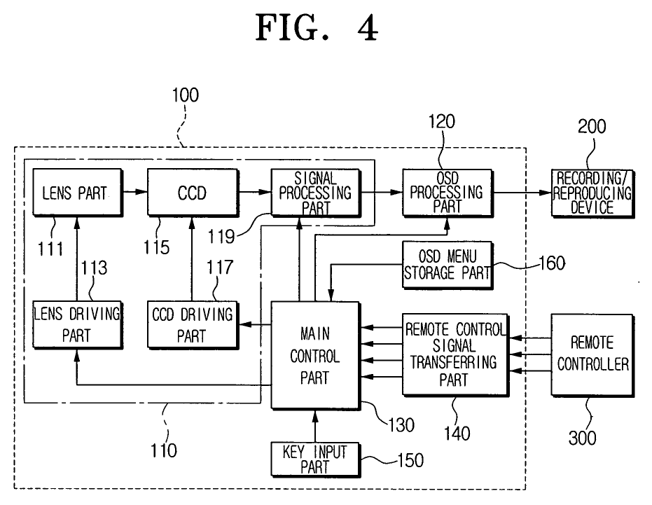

FIG. 4 is a block diagram illustrating a photographing system according to an embodiment of the present invention.

As shown in FIG. 4, the photographing system can include a photographing device 100, a recording/reproducing device 200, and a remote controller 300.

The photographing device 100 converts an optical signal incident through a lens into an electric signal, and provides an image signal created through a specified signal process of the converted electric signal to the recording/reproducing device 200. The photographing device 100 also controls respective modules in accordance with a user's control commands input through a key input part 150 or the remote controller 300. The photographing device 100 includes a photographing part 110, an OSD (On Screen Display) processing part 120, a main control part 130, a remote control signal transferring part 140, a key input part 150, and an OSD menu storage part 160.

The photographing part 110 converts the optical signal incident through the lens into the electric signal, and outputs the image signal created through the specified signal process of the converted electric signal. The photographing part 110 includes a lens part 111, a lens driving part 113, a CCD (Charge Coupled Device) 115, a CCD driving part 117, and a signal processing part 119.

The CCD 115 converts the optical signal incident through the lens part 111 into the electric signal. The lens driving part 113 and the CCD driving part 117 drive the lens part 111 and the CCD 115, respectively, under the control of the main control part 130. Specifically, the lens driving part 113 is provided with a zooming motor. for driving the lens part 111 so as to enlarge/reduce the magnification of an object to be photographed, a focusing motor for driving the lens part 111 so as to adjust the focal distance to a long distance/short distance, and an iris motor for driving an iris provided in the lens part 111 for adjusting a quantity of light incident to the CCD 115.

The signal processing part 119, under the control of the main control part 130, removes noise from an output signal of the CCD 115, adjusts a gain so as to keep the level of a signal constant, and converts the signal into a digital signal. The signal processing part 119 also adjusts a luminance value, a chrominance value, and other such values, adjusts an image size (i.e., digital zoom), and compresses the image signal to be recorded as an MPEG format signal.

The OSD processing part 120 overlaps an OSD menu on the image signal provided from the photographing part 110 under the control of the main control part 130. Specifically, if a user inputs a command to display a menu display command, related information display command, or other such information through the key input part 150 or the remote controller 300, the main control part 130, which has received this command, reads out a corresponding OSD menu, display characters and so forth, from the OSD menu storage part 160, and provides the read OSD menu or the display characters to the OSD processing part 120. The OSD processing part 120 then overlaps the OSD menu or the display characters on the image provided from the photographing part 110.

The main control part 130 receives the user's control commands through the key input part 150 or the remote controller 300, and controls the operation of the photographing part 110 and the OSD processing part 120 accordingly.

The remote control signal transferring part 140 provides remote control signals output from the remote controller 300 to the main control part 130.

The recording/reproducing device 200 receives the image signal output from the photographing device 100, and displays the image signal on a display device or records the image signal in a recording medium.

The remote controller 300 allows inputting a user's commands, and is provided with a plurality of manipulation buttons.

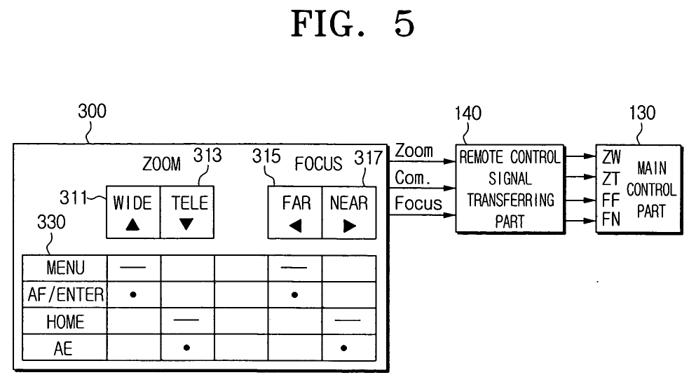

Hereinafter, the process of transferring the control commands input by the user through the remote controller 300 to the main control part 130 and the resulting process of controlling the photographing part 110, which is performed by the main control part 130 that has received the control commands, will be described in greater detail with reference to FIGS. 5 to 8.

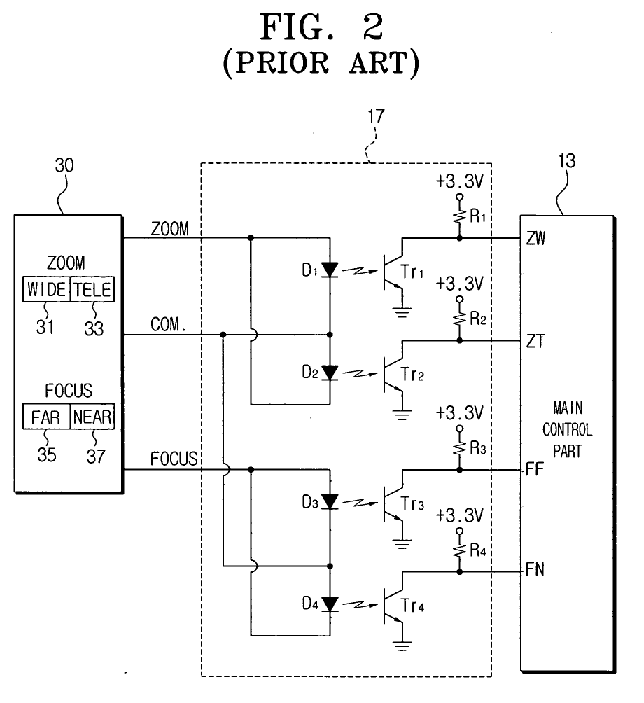

FIG. 5 is a block diagram illustrating a photographing system which controls a photographing device 100 in accordance with control commands made by combining a plurality of remote control signals output from a remote controller 300 according to an embodiment of the present invention. According to the remote controller 300 as illustrated in FIG. 5, unlike the remote controller 30 of FIG. 2, the respective manipulation buttons 311 to 317 can direct two or more control commands, and the two or more control commands can be marked on the respective manipulation buttons 311 to 317. For example, on the manipulation buttons 311 to 317 of the remote controller 300, symbols are marked as “▴”, “▾”, “ [symbol] ” and “ [symbol] ” for inputting cursor movement commands, respectively, in addition to the “WIDE”, “TELE”, “FAR” and “NEAR” commands.

Unlike the remote controller 30 as shown in FIG. 2, the remote controller 300 as shown in FIG. 5 enables simultaneous selection of two or more of the plurality of manipulation buttons 311 to 317. Under the manipulation buttons 311 to 317 of the remote controller 300, manipulation button use information 330 is marked, which comprises guide information on control commands/functions input when two manipulation buttons are simultaneously selected. In the manipulation button use information 330, a symbol “●” indicates that a manipulation button is to be pressed for a short time, and a symbol “—” indicates that the manipulation button is to be pressed for a long time.

According to the manipulation button use information 330, a menu display simultaneously pressed for a long time, while an auto-focusing (AF) setting command is input if the “WIDE ▴” button 311 and the “FAR [symbol] ” button 315 are simultaneously pressed for a short time. In the case where a menu is displayed, an enter command can be provided for selecting/executing a menu item where the cursor is placed. Also, a restoration (i.e., HOME) command can be provided for restoring an environment setting value of each module provided in the photographing part 110 to a basic value if the “TELE ▾” button 313 and the “NEAR [symbol] ” button 317 are simultaneously pressed for a long time, while an auto-exposure (AE) setting command is input if the “TELE ▾” button 313 and the “NEAR [symbol] ” button 317 are simultaneously pressed for a short time.

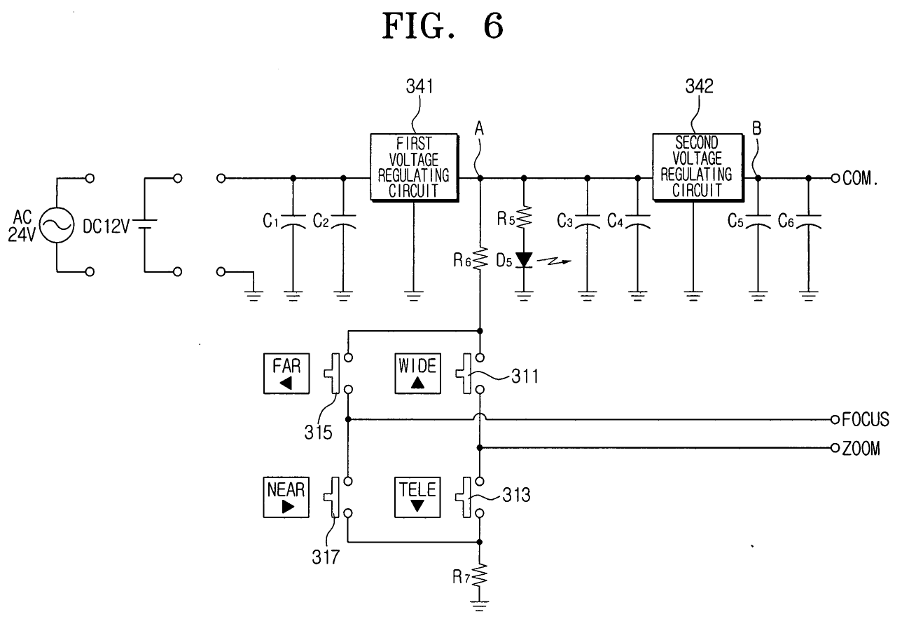

FIG. 6 is a schematic illustrating a remote controller 300 of FIG. 5. The remote controller 300 can use any number of power supplies, such as a power supply of AC 24V or DC 12V. First and second voltage regulating circuits 341 and 342 output constant voltages even if the load is varied. In the embodiment of the present invention, a voltage of 10V is output from the first voltage regulating circuit 341, and a voltage of 5V is output from the second voltage regulating circuit 342. Accordingly, the voltage of node A becomes 10V, and the voltage of a node B becomes 5V, so that a voltage of 5V is applied to the “Com.” terminal.

The first to sixth capacitors C₁ to C₆ are bypass capacitors for removing noise components. A fifth diode D₅ is turned on when the power is supplied, so as to inform a user that the remote controller 300 is turned on.

If only the “WIDE ▴” button 311 is pressed, a voltage of 10V, which is the same as the voltage of the node A, is applied to a “Zoom” terminal regardless of a voltage drop caused by a resistor R₆. Accordingly, the voltage difference between the “Zoom” terminal and the “Com.” terminal of the remote control signal transferring part 140 becomes +5V (i.e., 10V−5V=+5V), and this causes a low-level signal to be input to a “ZW (Zoom_Wide)” port of the main control part 130, and a high-level signal to be input to other ports (See Table 1).

If only the “TELE ▾” button 313 is pressed, a voltage of 0V is applied to the “Zoom” terminal regardless of a voltage drop caused by a resistor R₇. Accordingly, the voltage difference between the “Zoom” terminal and the “Com.” terminal of the remote control signal transferring part 140 becomes −5V (i.e., 0V−5V=−5V), and this causes a low-level signal to be input to a “ZT (Zoom_Tele)” port of the main control part 130, and a high-level signal to be input to other ports.

If only the “FAR [symbol] ” button 315 is pressed, a voltage of 10V, which is the same as the voltage of the node A, is applied to a “Focus” terminal regardless of a voltage drop caused by a resistor R₆. Accordingly, the voltage difference between the “Focus” terminal and the “Com.” terminal of the remote control signal transferring part 140 becomes +5V (i.e., 10V−5V=+5V), and this causes a low-level signal to be input to a “FF (Focus_Far)” port of the main control part 130, and a high-level signal to be input to other ports.

If only the “NEAR [symbol] ” button 317 is pressed, a voltage of 0V is applied to the “Focus” terminal regardless of a voltage drop caused by a resistor R₇. Accordingly, the voltage difference between the “Focus” terminal and the “Com.” terminal of the remote control signal transferring part 140 becomes −5V (i.e., 0V−5V=−5V), and this causes a low-level signal to be input to a “FN (Focus_Near)” port of the main control part 130, and a high-level signal to be input to other ports.

If the “WIDE ▴” button 311 and the “FAR [symbol] ” button 315 are simultaneously pressed, both the voltage difference between the “Zoom” terminal and the “Com.” terminal, and the voltage difference between the “Focus” terminal and the “Com.” terminal of the remote control signal transferring part 140 become +5V, and this causes a low-level signal to be input to the “ZW” port and the “FF” port of the main control part 130, and a high-level signal to be input to other ports.

If the “TELE ▾” button 313 and the “NEAR [symbol] ” button 317 are simultaneously pressed, both the voltage difference between the “Zoom” terminal and the “Com.” terminal, and the voltage difference between the “Focus” terminal and the “Com.” terminal of the remote control signal transferring part 140 become −5V, and this causes a low-level signal to be input to the “ZT” port and the “FN” port of the main control part 130, and a high-level signal to be input to other ports.

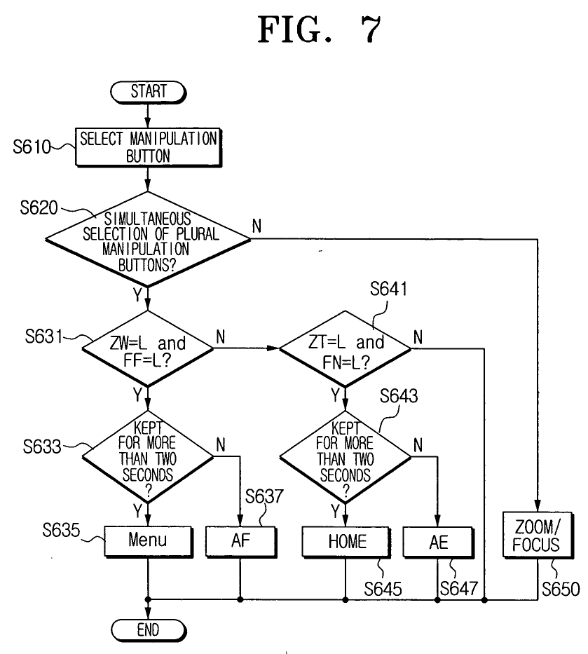

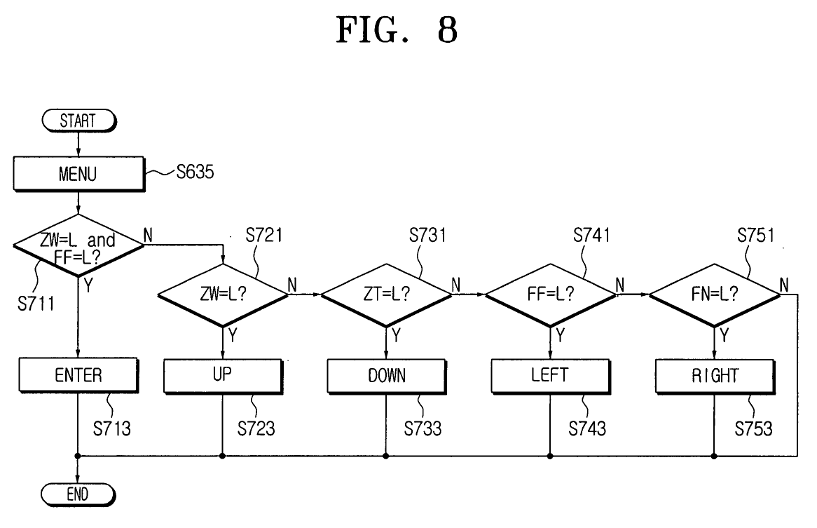

Hereinafter, with reference to FIGS. 7 and 8, a process of controlling the photographing part 110, which is performed by the main control part 130 that has received control commands, will be described in greater detail. FIGS. 7 and 8 are flowcharts illustrating a method for controlling a photographing device in accordance with control commands made by combining a plurality of remote control signals output from the remote controller according to an embodiment of the present invention.

Referring to FIG. 7, if a user selects at least one of the manipulation buttons 311 to 317 provided in the remote controller 300 in order to send control commands to the photographing device 100, a low-level signal is input to the corresponding port of the main control part 130 at step S610.

If two or more manipulation buttons are simultaneously selected at step S610, and the low-level signal is simultaneously input to two or more ports of the main control part 130 at step S620, the main control part 130 judges the kind of ports to which the low-level signal has been input. If the “WIDE ▴” button 311 and the “FAR [symbol] ” button 315 of the remote controller 300 are simultaneously pressed, and both the voltage difference between the “Zoom” terminal and the “Com.” terminal, and the voltage difference between the “Focus” terminal and the “Com.” terminal of the remote control signal transferring part 140 become +5V to cause the low-level signal to be simultaneously input to the “ZW” port and the “FF” port of the main control part 130 at step S631, the main control part 130 checks the time for which the low-level signal is input to the “ZW” port and the “FF” port.

If the “WIDE ▴” button 311 and the “FAR [symbol] ” button 315 of the remote controller 300 are simultaneously selected (i.e., pressed) for more than a predetermined time (for example, two seconds), and the low-level signal is continuously input to both the “ZW” port and the “FF” port of the main control part 130 for more than the predetermined time at step S633, the main control part 130 recognizes this as a menu display command. Accordingly, the main control part 130 reads out the corresponding OSD menu from the OSD menu storage part 160, and provides the OSD menu to the OSD processing part 120. In this case, the OSD processing part 120 overlaps the OSD menu on the image provided from the photographing part 110 and outputs the overlapped image to the recording/reproducing device 200, so that the user can interface the OSD menu at step S635.

By contrast, if the low-level signal is input to both the “ZW” port and the “FF” port of the main control part 130 for less than the predetermined time at step S633, the main control part 130 recognizes this as an auto-focusing (AF) setting command. Accordingly, the main control part 130 performs the AF by automatically controlling the focus motor provided in the lens driving part 113 at step S637.

If the “TELE ▾” button 313 and the “NEAR [symbol] ” button 317 of the remote controller 300 are simultaneously selected at step S610, and both the voltage difference between the “Zoom” terminal and the “Com.” terminal, and the voltage difference between the “Focus” terminal and the “Com.” terminal of the remote control signal transferring part 140 become −5V to cause the low-level signal to be simultaneously input to the “ZT” port and the “FN” port of the main control part 130 at step S641, the main control part 130 checks the time for which the low-level signal is input to the “ZT” port and the “FN” port.

If the “TELE ▾” button 313 and the “NEAR [symbol] ” button 317 of the remote controller 300 are simultaneously selected (i.e., pressed) for more than a predetermined time (for example, two seconds), and the low-level signal is continuously input to both the “ZT” port and the “FN” port of the main control part 130 for more than the predetermined time at step S643, the main control part 130 recognizes this as a restoration (HOME) command. Accordingly, the main control part 130 resets (i.e., restores) environment setting values of respective modules provided in the photographing part 110 to basic values (i.e., default values) at step S645.

By contrast, if the low-level signal is input to both the “ZT” port and the “FN” port of the main control part 130 for less than the predetermined time at step S643, the main control part 130 recognizes this as an auto-exposure (AE) setting command. Accordingly, the main control part 130 performs the AE by automatically controlling the iris motor provided in the lens driving part 113 at step S647.

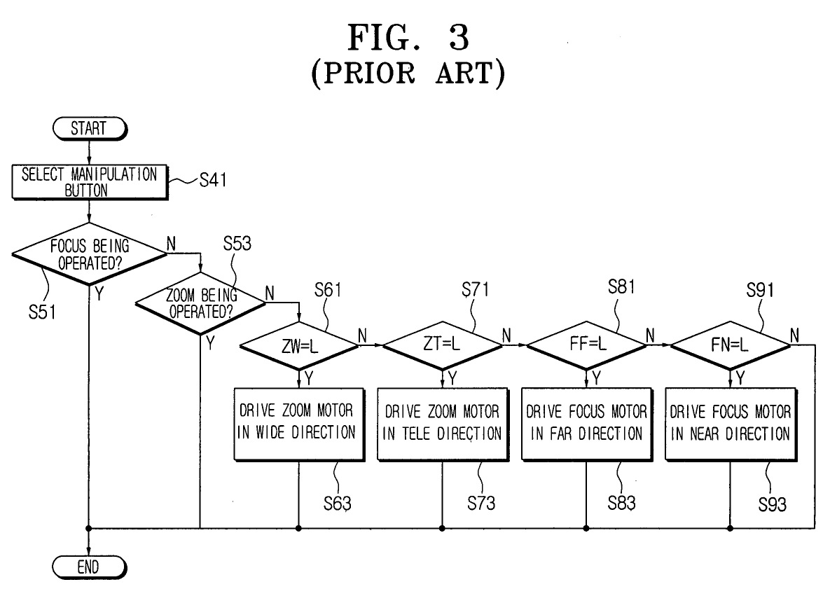

If only one manipulation button is selected at step S610, the main control part 130 controls zoom and focus according to the input control commands at step S650, the detailed process of which is the same as that as illustrated in FIG. 3.

Hereinafter, the operation performed by selecting the manipulation buttons of the remote controller 300 when the menu is displayed through the recording/reproducing device 200 at step S635 will be explained with reference to FIG. 8.

If the “WIDE ▴” button 311 and the “FAR [symbol] ” button 315 of the remote controller 300 are simultaneously selected, and both the voltage difference between the “Zoom” terminal and the “Com.” terminal, and the voltage difference between the “Focus” terminal and the “Com.” terminal of the remote control signal transferring part 140 become +5V to cause the low-level signal to be simultaneously input to the “ZW” port and the “FF” port of the main control part 130 at step S711 in a state where the menu is displayed through the recording/reproducing device 200 at step S635, the main control part 130 recognizes this as an enter command for selecting/executing a menu item on which the cursor is placed in the menu. The main control part 130 then performs the enter command at step S713. At this time, if a lower menu exists, one which is dependent on the menu item on which the cursor is placed, the main control part 130 reads out the lower menu from the OSD menu storage part 160 and provides the lower menu to the OSD processing part 120, so that the lower menu is displayed through the recording/reproducing device 200. If the lower menu of the menu item on which the cursor is placed does not exist, the main control part 130 performs a control operation corresponding to the menu item.

If the “WIDE ▴” button 311 of the remote controller 300 is selected and the voltage difference between the “Zoom” terminal and the “Com.” terminal of the remote control signal transferring part 140 becomes +5V to cause the low-level signal to be input to the “ZW” port of the main control part 130 at step S721, the main control part 130 recognizes this as a command for moving the cursor displayed on the menu upward, and controls the OSD processing part 120 to move the cursor upward at step S723.

If the “TELE ▾” button 313 of the remote controller 300 is selected and the voltage difference between the “Zoom” terminal and the “Com.” terminal of the remote control signal transferring part 140 becomes −5V to cause the low-level signal to be input to the “ZT” port of the main control part 130 at step S731, the main control part 130 recognizes this as a command for moving the cursor displayed on the menu downward, and controls the OSD processing part 120 to move the cursor downward at step S733.

If the “FAR [symbol] ” button 315 of the remote controller 300 is selected and the voltage difference between the “Focus” terminal and the “Com.” terminal of the remote control signal transferring part 140 becomes +5V to cause the low-level signal to be input to the “FF” port of the main control part 130 at step S741, the main control part 130 recognizes this as a command for moving the cursor displayed on the menu to the left, and controls the OSD processing part 120 to move the cursor to the left at step S743.

If the “NEAR [symbol] ” button 317 of the remote controller 300 is selected and the voltage difference between the “Focus” terminal and the “Com.” terminal of the remote control signal transferring part 140 becomes −5V to cause the low-level signal to be input to the “FN” port of the main control part 130 at step S751, the main control part 130 recognizes this as a command for moving the cursor displayed on the menu to the right, and controls the OSD processing part 120 to move the cursor to the right at step S753.

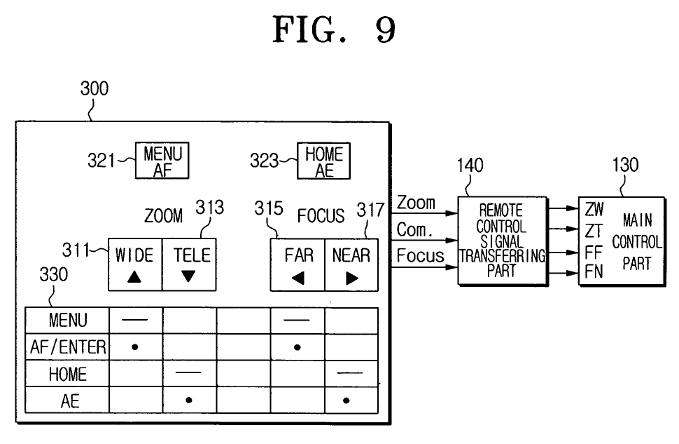

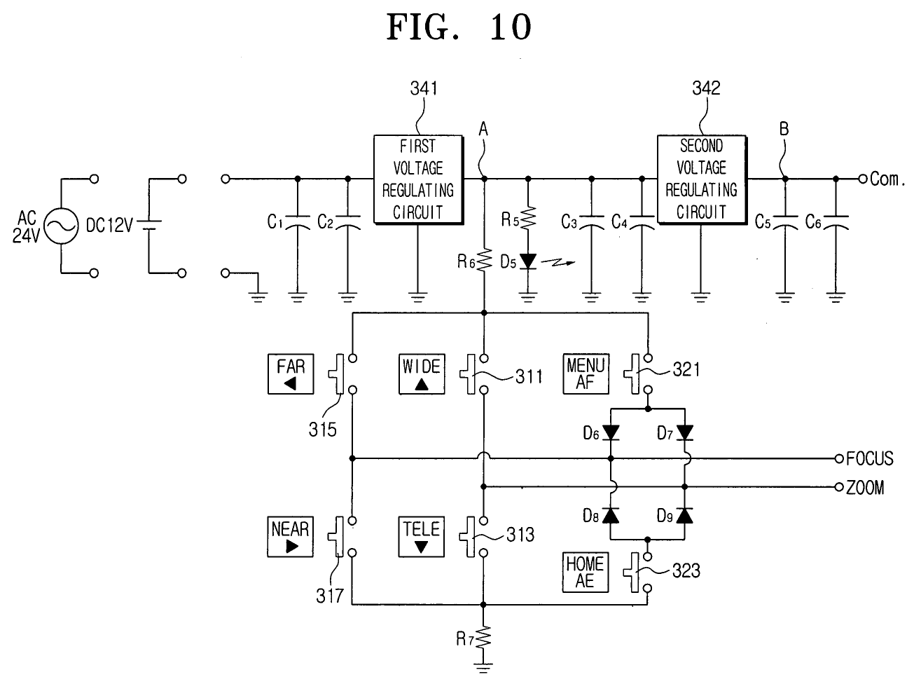

Hereinafter, a method for controlling a photographing device in accordance with control commands made by combining a plurality of remote control signals output from a remote controller according to another embodiment of the present invention will be described in greater detail with reference to FIGS. 9 and 10.

The remote controller 300 of FIG. 9 is provided with an additional “MENU/AF” manipulation button 321 and a “HOME/AE” manipulation button 323 in comparison to the remote controller 300 of FIG. 5. If the user selects the “MENU/AF” manipulation button 321, a control command is input which is the same as that provided in the case where the “WIDE ▴” button 311 and the “FAR [symbol] ” button 315 of the remote controller 300 are simultaneously selected. If the user selects the “HOME/AE” manipulation button 323, a control command is input which is the same as that provided in the case where the “TELE ▾” button 313 and the “NEAR [symbol] ” button 317 of the remote controller 300 are simultaneously selected.

Hereinafter, the process of transferring control commands to the main control part 130 in the event that the user selects the “MENU/AF” manipulation button 321 or the “HOME/AE” manipulation button 323 will be described in greater detail with reference to FIG. 10. The circuit of the remote controller 300 of FIG. 10 is provided with the additional “MENU/AF” manipulation button 321, the “HOME/AE” manipulation button 323, and the sixth to ninth diodes D₆ to D₉ in comparison to the circuit of the remote controller 300 of FIG. 6.

If the “MENU/AF” manipulation button 321 is selected, the sixth diode D₆ and the seventh diode D₇ are turned on, and a voltage of 10V, which is the same as the voltage of the node A, is applied to the “Zoom” terminal and the “Focus” terminal regardless of a voltage drop caused by the resistor R₆. Accordingly, both the voltage difference between the “Zoom” terminal and the “Com.” terminal, and the voltage difference between the “Focus terminal and the “Com.” terminal of the remote control signal transferring part 140 become +5V (i.e., 10V−5V=+5V), and this causes a low-level signal to be input to the “ZW” port and the “FF” port of the main control part 130, and a high-level signal to be input to other ports. Accordingly, a control command is input which is the same as that provided in the case where the “WIDE ▴” button 311 and the “FAR [symbol] ” button 315 of the remote controller 300 are simultaneously selected, and thus, the step S631 of FIG. 7 is performed.

If the “MENU/AE” manipulation button 323 is selected, the eighth diode D₈ and the ninth diode D₉ are turned on, and a voltage of OV is applied to the “Zoom” terminal and the “Focus” terminal regardless of a voltage drop caused by the resistor R₇. Accordingly, both the voltage difference between the “Zoom” terminal and the “Com.” terminal, and the voltage difference between the “Focus terminal and the “Com.” terminal of the remote control signal transferring part 140 become −5V (i.e., 0V−5V=−5V), and this causes a low-level signal to be input to the “ZT” port and the “FN” port of the main control part 130, and a high-level signal to be input to other ports. Accordingly, a control command is input which is the same as that provided in the case where the “TELE ▾” button 313 and the “NEAR [symbol] ” button 317 of the remote controller 300 are simultaneously selected, and thus, the step S641 of FIG. 7 is performed.

As described above, by selecting only one manipulation button, a control command can be input which is the same as that provided in the case where two manipulation buttons are simultaneously selected. Although the manipulation buttons are added, there is no change in the number of ports allocated for inputting remote control signals to the main control part 130, and thus the embodiments of the present invention can be implemented by the design of the remote controller 300 only. Since control commands frequently input by the user can be input using only one manipulation button, the inconvenience caused by the user's simultaneous input of two manipulation buttons can be prevented.

Referring again to the example implementation of FIG. 7, the simultaneous input of two manipulation buttons was described in order to input control commands “Menu”, “AF”, “Home” and “AE”, and not the control commands corresponding to respective manipulation buttons 311 to 317 provided in the remote controller 300. However, it is also possible to input the control commands “Menu”, “AF”, “Home” and “AE” by selecting only one manipulation button for more than a predetermined time (for example, more than two seconds).

Also, referring to FIG. 7, only an example implementation for combining the “WIDE ▴” button 311 and the “FAR [symbol] ” button 315 of the remote controller 300, and an example implementation for combining the “TELE ▾” button 313 and the “NEAR [symbol] ” button 317 of the remote controller 300 were described. However, it is also possible to input the control commands by combining the “WIDE ▴” button 311 and the “NEAR [symbol] ” button 317, or combining the “TELE ▾” button 313 and the “FAR [symbol] ” button 315.

As described above, according to the present invention, control commands can be input to a photographing device using a remote controller provided with a plurality of manipulation buttons, and the photographing device can perform a control operation in accordance with a new control command created by combining a plurality of remote control signals input to the photographing device by simultaneously selecting the plurality of manipulation buttons. Accordingly, in the event that the photographing device is located in a remote location, such as on a ceiling of a building, the inconvenience caused by the user's direct manipulation of the key input part or caused by the input of the control commands using a serial communication between the user's PC and the photographing device can be prevented. Also, there is no requirement to increase the number of ports allocated to receive the remote control signals of the main control part in order to input more control commands through the remote controller.

The foregoing embodiments and advantages are merely exemplary and are not to be construed as limiting the present invention. The present teaching can be readily applied to other types of apparatus. Also, the description of the embodiments of the present invention is intended to be illustrative, and not to limit the scope of the claims, and many alternatives, modifications, and variations will be apparent to those skilled in the art.

1. A photographing system comprising:
a photographing part for converting an optical signal incident through a lens part into an electric signal, and for outputting an image signal created through a specified signal process of the converted electric signal;
an input part, comprising first and second manipulation buttons for inputting first and second control commands, respectively, by selecting at least one of the first and second manipulation buttons; and
a control part for controlling the photographing part in accordance with any one of the first and second control commands if the corresponding one of the first and second manipulation buttons is selected, and controlling the photographing part in accordance with a third control command if both the first and second manipulation buttons are selected.

2. The photographing system as claimed in claim 1, wherein the control part controls the photographing part in accordance with a fourth control command if both the first and second manipulation buttons are continuously selected for more than a predetermined time.

3. The photographing system as claimed in claim 2, wherein the input part further comprises a third manipulation button for inputting any one of the third and fourth control commands; and
wherein the control part controls the photographing part in accordance with the third control command if the third manipulation button in the input part is selected for less than a predetermined time, and wherein the control part controls the photographing part in accordance with the fourth control command if the third manipulation button is continuously selected for more than the predetermined time.

4. The photographing system as claimed in claim 2, wherein the control part controls the photographing part in accordance with the third control command if the first manipulation button is continuously selected for more than a predetermined time, and wherein the control part controls the photographing part in accordance with the fourth control command if the second manipulation button is continuously selected for more than the predetermined time.

5. The photographing system as claimed in claim 1, wherein the third control command comprises one of a menu display command, a restoration command for restoring an environment setting value of the photographing part to a basic value, an auto-focusing setting command and an auto-exposure setting command.

6. The photographing system as claimed in claim 2, wherein the fourth control command comprises one of a menu display command, a restoration command for restoring an environment setting value of the photographing part to a basic value, an auto-focusing setting command and an auto-exposure setting command.

7. A method for controlling a photographing system having a photographing part for converting an optical signal incident through a lens part into an electric signal and for outputting an image signal created through a specified signal process of the converted electric signal, and an input part comprising first and second manipulation buttons, the method comprising the steps of:
a) selecting at least one of the first and second manipulation buttons for inputting first and second control commands;
b) controlling the photographing part in accordance with any one of the first and second control commands if the corresponding one of the first and second manipulation buttons is selected at step a); and
c) controlling the photographing part in accordance with a third control command if both the first and second manipulation buttons are selected at step a).

8. The method as claimed in claim 7, further comprising the step of:
d) controlling the photographing part in accordance with a fourth control command if both the first and second manipulation buttons are continuously selected for more than a predetermined time at step a).

9. The method as claimed in claim 8, wherein the input part further comprises a third manipulation button for inputting any one of the third and fourth control commands and wherein the method further comprises the steps of:
e) controlling the photographing part in accordance with the third control command if the third manipulation button in the input part is selected for less than a predetermined time at step a); and
f) controlling the photographing part in accordance with the fourth control command if the third manipulation button is continuously selected for more than the predetermined time at step a).

10. The method as claimed in claim 8, further comprising the steps of:
g) controlling the photographing part in accordance with the third control command if the first manipulation button is continuously selected for more than a predetermined time; and
h) controlling the photographing part in accordance with the fourth control command if the second manipulation button is continuously selected for more than the predetermined time.

11. The method as claimed in claim 7, wherein the third control command comprises one of a menu display command, a restoration command for restoring an environment setting value of the photographing part to a basic value, an auto-focusing setting command and an auto-exposure setting command.

12. The method as claimed in claim 8, wherein the fourth control command comprises one of a menu display command, a restoration command for restoring an environment setting value of the photographing part to a basic value, an auto-focusing setting command and an auto-exposure setting command.
